(19) United States
(12) Patent Application Publication
(10) Pub. No.: US 2007/0145028 A1
(43) Pub. Date: Jun. 28, 2007

(54) Welding unit and welding method by means of which at least two different welding processes may be combined

(75) Inventor: Josef Artelsmair, Wartberg/Krems (AT)

Correspondence Address: WILLIAM COLLARD;COLLARD & ROE, P.C., 1077 NORTHERN BOULEVARD, ROSLYN, NY, 11576, US

(73) Assignee: FRONIUS INTERNATIONAL GMBH, A-4643 PETTENBACH 319 (AT)

(21) Appl. No.: 10/583,060

(22) PCT Filed: Dec. 14, 2004
(86) PCT No.: PCT/AT04/00439

§ 371 Date: Jun. 15, 2006

(30) Foreign Application Priority Data
Dec. 15, 2003 (AT) 2014/2003

(51) Int. Cl. B23K 9/10

(52) U.S. Cl. 219/137.71

(57) ABSTRACT

A welding unit including a welding apparatus with a welding torch unit connectable thereto via a hose pack. At least one control device, a welding current source and optionally a wire feeder unit are arranged in the welding apparatus. The welding torch unit is formed by at least two separate welding torches intended to carry out at least two independent, separate welding processes. The first welding torch is configured to carry out a welding process and at least a second welding torch is configured to carry out a cold-metal transfer welding process with a forward-backward movement of a welding wire, and that a device for synchronizing the welding processes carried out by the at least two welding torches is provided.

### BACKGROUND OF THE INVENTION

1. Field of the Invention

The invention relates to a welding unit including a welding apparatus with a welding torch unit connectable thereto via a hose pack, wherein at least one control device, a welding current source and optionally a wire feeder unit are arranged in the welding apparatus, wherein the welding torch unit is formed by at least two separate welding torches intended to carry out at least two independent, separate welding processes.

The invention further relates to a welding method combining at least two different welding processes.

The term “welding torch” is intended to encompass various conventional welding torches as well as laser torches and the like.

In known welding methods, any parameter may be adjusted via an input and/or output device provided on the welding apparatus. In doing so, a suitable welding process such as, for instance a pulse welding process or a spray-arc welding process or a short-arc welding process is selected with the respective parameters being adjusted. In addition, it is frequently possible to choose a suitable ignition process for igniting the electric arc. After having started the welding procedure, the adjusted welding process, for instance a pulse welding process, is carried out upon ignition of the electric arc by the adjusted ignition process. During the welding procedure, various parameters such as, for instance, the welding current, the wire advance speed etc. can be changed for the respectively selected welding process. Switching to another welding process, for instance a spray-arc welding process, however, is not feasible. To this end, the as-performed welding process, for instance a pulse welding process, has to be interrupted so as to allow for the realization of another welding process, for instance a spray-arc welding process, by an appropriate, new selection and adjustment at the welding apparatus.

2. Prior Art

EP 1 084 789 A2 describes a method and device for protective-gas hybrid welding, in which a laser jet and an electric arc are generated by at least two electrodes under protective gases. This raises the chance of influencing the welding process and, in particular, provides for an enhanced option of automation, since the welding process is more readily influenceable by an increase in the electrode number, which also allows for a selective heat input.

WO 2001/38038 A2 relates to a laser hybrid welding torch combining a laser welding process with an electric arc welding process in order to improve the welding quality and welding process stabilization. There, the special arrangement of the individual assemblies relative to one another is essential for the melt bath produced by the laser jet to unite to a joint melt bath with the melt bath produced by the electric-arc welding process to thereby increase the stability of the arrangement and the penetration depth of the welding process.

### SUMMARY OF THE INVENTION

It is the object of the present invention to provide a welding unit and a welding method, by which the weld metal input and the heat or energy input into the workpiece are adjustable as independently of each other as possible.

The object according to the invention is achieved by an above-mentioned welding unit, wherein the first welding torch is configured to carry out a welding process and at least a second welding torch is configured to carry out a cold-metal transfer welding process with a forward-backward movement of a welding wire, and a device for synchronizing the welding processes carried out by the at least two welding torches is provided. By using a cold-metal transfer welding process, the energy and heat input can be reduced such that only little additional heat is introduced into the workpiece or sheet metals. Moreover, the gap bridging ability is substantially enhanced. Due to the time synchronization of the at least two welding processes, the welding processes can be optimally tuned to one another, thus allowing for the optimum adjustment of the heat or energy input into the workpiece. In addition, different welding wire materials and welding wire diameters can be used while enabling the control of the material input into the workpiece.

Further advantageous configurations are described in claims 2 to 13. The advantages resulting therefrom can be taken from the description and the previously described claim 1.

The object of the invention is also achieved by an above-mentioned welding method in which at least one welding process is comprised of a cold-metal transfer welding process, wherein a consumable welding wire is moved forward and backward and the at least two welding processes are synchronized in time.

Further characteristic features are described in claims 15 to 22.

### BRIEF DESCRIPTION OF THE DRAWINGS

The present invention will be explained in more detail by way of the attached drawings. Therein:

FIG. 1 is a schematic illustration of a welding unit or welding apparatus;

FIG. 2 is a schematic illustration of a welding apparatus according to the invention;

FIG. 3 depicts the power, voltage and movement graphs of a spray-arc and a cold-metal transfer welding process, respectively;

FIG. 4 depicts the power, voltage and movement graphs of a pulse and a cold-metal transfer welding process, respectively;

FIG. 5 depicts the power, voltage and movement graphs of a pulse and a cold-metal transfer welding process, respectively;

FIG. 6 is a schematic illustration of a welding apparatus according to the invention;

FIG. 7 depicts the power, voltage and movement graphs of two cold-metal transfer welding processes;

FIG. 8 depicts the power, voltage and movement graphs of two temporally offset cold-metal transfer welding process; and

FIGS. 9 to 11 are schematic illustrations of different welding apparatus according to the invention.

### DETAILED DESCRIPTION OF PREFERRED EMBODIMENTS OF THE INVENTION

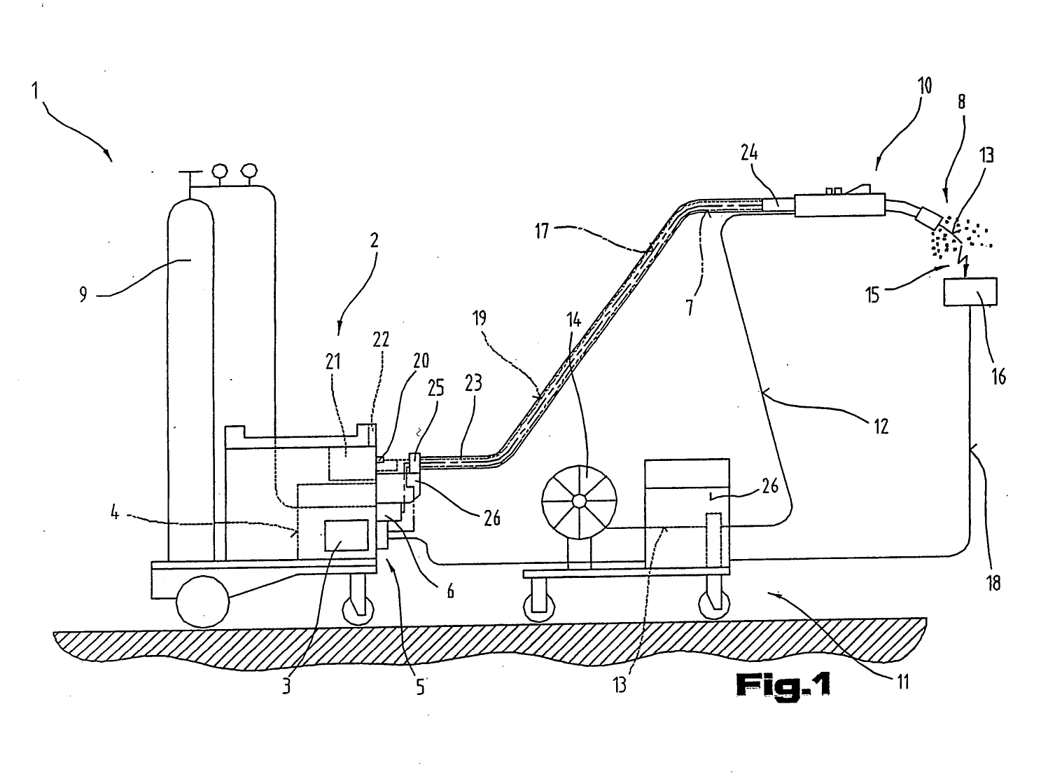

FIG. 1 depicts a welding apparatus 1, or welding unit, for various processes or methods such as, e.g., MIG/MAG welding or WIG/TIG welding, or electrode welding methods, double-wire/tandem welding methods, plasma or soldering methods etc.

The welding apparatus 1 comprises a power source 2 including a power element 3, a control device 4, and a switch member 5 associated with the power element 3 and control device 4, respectively. The switch member 5 and the control device 4 are connected to a control valve 6 arranged in a feed line 7 for a gas 8 and, in particular, a protective gas such as, for instance, carbon dioxide, helium or argon and the like, between a gas reservoir 9 and a welding torch 10 or torch.

In addition, a wire feeder 11, which is usually employed in MIG/MAG welding, can be controlled by the control device 4, whereby an additional material or welding wire 13 is fed from a feed drum 14 or wire coil into the region of the welding torch 10 via a feed line 12. It is, of course, possible to integrate the wire feeder 11 in the welding apparatus 1 and, in particular, its basic housing, as is known from the prior art, rather than designing the same as an accessory device as illustrated in FIG. 1.

It is also feasible for the wire feeder 11 to supply the welding wire 13, or filler metal, to the process site outside of the welding torch 10, to which end a non-consumable electrode is preferably arranged within the welding torch 10, as is usually the case with WIG/TIG welding.

The power required to build up an electric arc 15, in particular an operational electric arc, between the electrode and a workpiece 16 is supplied from the power element 3 of the power source 2 to the welding torch 10, in particular electrode, via a welding line 17, wherein the workpiece 16 to be welded, which is formed of several parts, is likewise connected with the welding apparatus 1 and, in particular, power source 2 via a further welding line 18, thus enabling a power circuit for a process to build up over the electric arc 15, or plasma jet formed.

To provide cooling of the welding torch 10, the welding torch 10 can be connected to a fluid reservoir, in particular a water reservoir 21, by a cooling circuit 19 via an interposed flow control 20, whereby the cooling circuit 19 and, in particular, a fluid pump used for the fluid contained in the water reservoir 21, is started as the welding torch 10 is put into operation, in order to effect cooling of the welding torch 10.

The welding apparatus 1 further comprises an input and/or output device 22, via which the most different welding parameters, operating modes or welding programs of the welding apparatus 1 can be set and called, respectively. In doing so, the welding parameters, operating modes or welding programs set via the input and/or output device 22 are transmitted to the control device 4, which subsequently controls the individual components of the welding unit or welding apparatus 1 and/or predetermines the respective set values for controlling.

In the exemplary embodiment illustrated, the welding torch 10 is, furthermore, connected with the welding apparatus 1 or welding unit via a hose pack 23. The hose pack 23 accommodates the individual lines from the welding apparatus 1 to the welding torch 10. The hose pack 23 is connected with the welding torch 10 via a coupling device 24, whereas the individual lines arranged in the hose pack 23 are connected with the individual connections of the welding apparatus 1 via connection sockets or plug-in connections. In order to ensure an appropriate strain relief of the hose pack 23, the hose pack 23 is connected with a housing 26, in particular the basic housing of the welding apparatus 1, via a strain relief means 25. It is, of course, also possible to use the coupling device 24 for connection to the welding apparatus 1.

It should basically be noted that not all of the previously mentioned components will have to be used or employed for the various welding methods or welding apparatus 1 such as, e.g., WIG devices or MIG/MAG apparatus or plasma devices. Thus, it is, for instance, feasible to devise the welding torch 10 as an air-cooled welding torch 10.

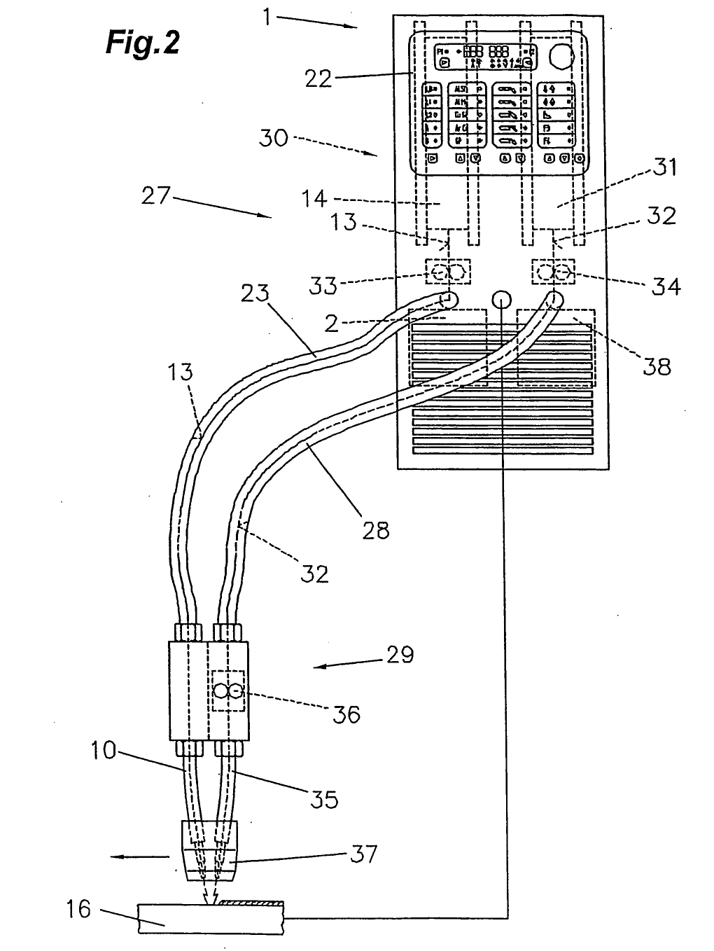

FIGS. 2 to 11 represent exemplary embodiments in which combinations of a welding process with a cold-metal transfer welding process are described. In the exemplary embodiment according to FIGS. 2 to 5, a MIG/MAG welding process is combined with the cold-metal transfer welding process. The illustrated welding unit 27 includes a welding device 1 with a welding torch unit 29 that is connectable to the same via two hose packs 23, 28. The welding torch unit 29 is comprised of at least two independent welding torches 10 and 35, whereby each of the welding torches 10, 35 is connected with the welding apparatus 1 via the respective hose pack 23, 28 so as to enable all of the components necessary for a welding process, such as, for instance, the gas 8, the energy supply, the cooling circuit 19, etc. to be provided to the welding torch unit 29. As already described with reference to FIG. 1, the welding apparatus 1 houses a control device 4, a welding current source 2 and a wire conveying device 30, which are not all illustrated in FIG. 2. The wire conveying device 30 in the example illustrated is integrated in the welding apparatus 1 and comprises two feed drums 14, 31 for a welding wire 13, 32, which is conveyed to the welding torches 10, 35 of the welding torch unit 29 by a respective drive unit 33, 34. Each of the welding torches 10, 35 of the welding torch unit 29 may additionally comprise a drive unit 36 (schematically illustrated in broken lines). Further-more, the welding torch unit 29 in the exemplary embodiment illustrated comprises a common gas nozzle 37 for the welding torches 10, 35. In the welding apparatus 1 only one power source 2 is provided to supply energy to the welding torch unit 29, which power source 2 is alternately connected with the respectively active welding torch 10, 35. It is, of course, also possible to control the two welding torches 10, 35 arranged in the welding torch unit 29 via two separately controllable power sources 2 and 38, which are arranged in the welding apparatus 1.

A description of the functions of the individual assemblies or components such as, for instance, wire conveyance, power supply, welding torch structure, welding apparatus settings etc. has been omitted, since these are already known from the prior art.

Basically, it should be noted that in the illustrated variant embodiments the first welding torch 10 is designed to carry out any welding process while the second welding torch 35 is designed to carry out a cold-metal transfer welding process. In a preferred manner, the first welding torch 10 is formed by a MIG/MAG torch in the exemplary embodiments according to FIGS. 2 to 5. In those cases, the first welding torch 10 precedes the second welding torch 35, viewed in the welding direction. It is, of course, also possible to arrange the second welding torch 35 upstream of the first welding torch 10, or to laterally offset the welding torches 10 and 35 relative to each other in the longitudinal direction of the weld.

An advantage of this configuration resides in that two different welding processes can be performed using, for instance, different wire materials as well as different wire diameters. Thus, in root welding, an enhanced gap bridging ability is, for instance, ensured, as will, for instance, be obtained by laterally offsetting the at least two welding wires 13.

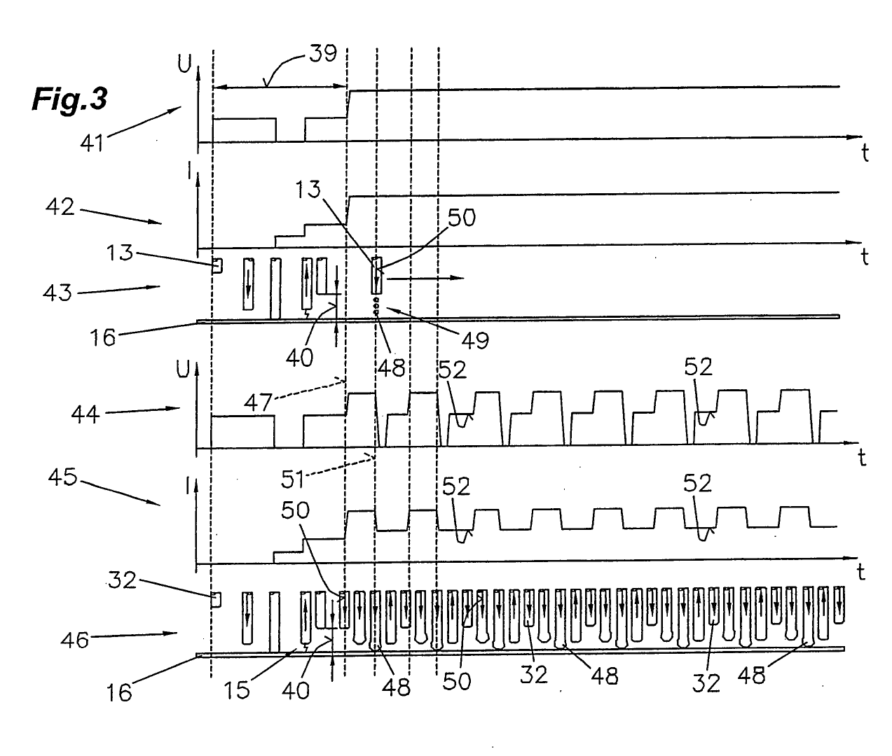

It is essential in the configuration according to the invention that the welding torch unit 29 comprises two separate welding torches 10, 35, or the electrically separated components of welding torches 10, 35, arranged in a structural unit so as to render feasible the use of two independently operating welding methods. Thus, a MAG welding process is, for instance, combined with a cold-metal transfer welding process, as is illustrated in FIGS. 3 to 5 by way of power, voltage and wire movement graphs. The combined welding methods according to the invention, for instance, use the lift arc principle for the ignition of the electric arc 15 (ignition phase 39). Since this is a method known from the prior art, it will not be described in detail. It is merely pointed out that the welding wire 13, 32 is moved forward until contacting the workpiece 16, whereupon the welding wire movement is subsequently reversed to convey the welding wire 13, 32 back to a predefined distance 40 from the workpiece 16, whereupon the welding wire movement will again be reversed. By powering the welding wire 13, 32 with a defined current intensity from the time of the short-circuit, which current intensity is chosen to prevent incipient melting or melting open of the welding wire 13, 32, the ignition of the electric arcs 15 for the two welding wires 13, 32 will take place independently of each other during the rearward movement and lifting of the welding wire 13, 32.

Graphs 41, 42 and 43 depict the MAG welding process, while graphs 44, 45 and 46 illustrate the cold-metal transfer welding process.

In the MAG welding process, the welding current I is definedly increased after having completed the ignition phase 39 at time 47 and the welding wire 13 is conveyed in the direction of the workpiece 16. The continuously applied welding current I causes a droplet 48 to form on the end of the welding wire, which will detach from the welding wire 13 after a defined period of time as a function of the intensity of the welding current I, thus forming a droplet chain 49. This procedure is then periodically repeated. The welding wire 13 is, thus, moved only in the direction of the workpiece 16—arrow 50—, whereas in the cold-metal transfer welding process a forward-backward movement of the welding wire 13 takes place, as is apparent from graph 46.

The cold-metal transfer welding process is characterized in that the welding wire 32, from a starting position, i.e., a distance 40 from the workpiece 16, carries out a movement in the direction of the workpiece 16—arrow 50—, as is indicated in graph 46 as of time 47. The welding wire 32 is, thus, conveyed towards the workpiece 16 until contacting the workpiece 16—time 51—, after this, following the formation of a short-circuit, the wire conveyance is reversed and the welding wire 32 is conveyed back from the workpiece 16 as far as to the predefined distance 40, i.e., preferably, back into the starting position. In order to ensure the formation of a droplet, or incipient melting of the welding wire end, during the cold-metal transfer welding process, the welding current I during the forward movement of the welding wire 32 in the direction of the workpiece 16—arrow 50—is changed and, in particular, raised relative to a base current 52 defined to maintain the electric arc 15 without any substantial incipient melting of the welding wire 32, as is apparent from graphs 44 and 45. Hence, the current I is controlled in a manner that the incipient melting of the welding wire 32 occurs, i.e. a droplet 48 forms, at a forward movement. By the welding wire 32 being immersed into the melt bath (not illustrated) and subsequently moved backwards, the droplet 48 formed, or the incipiently melted material, will then be detached from the welding wire 32. In this respect, it is, of course, also possible to carry out an impulsive increase in the welding current I in order to promote droplet detachment. It is, furthermore, feasible to change and, in particular, increase the wire conveying speed during the cold-metal transfer welding process in order to ensure, for instance, a more rapid realization of the cold-metal transfer welding process.

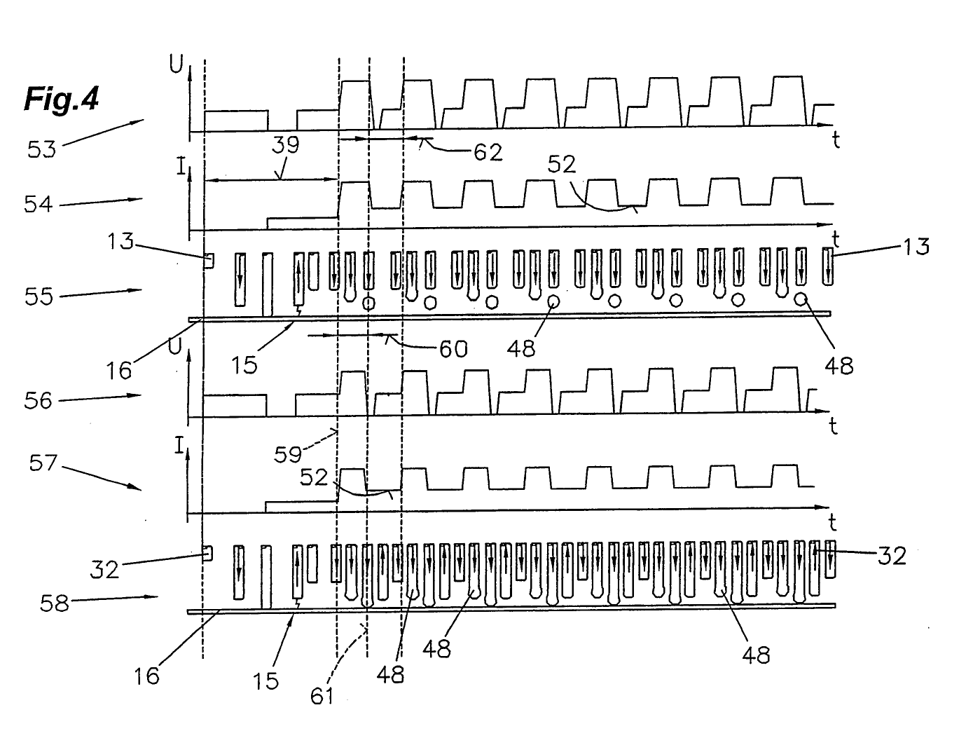

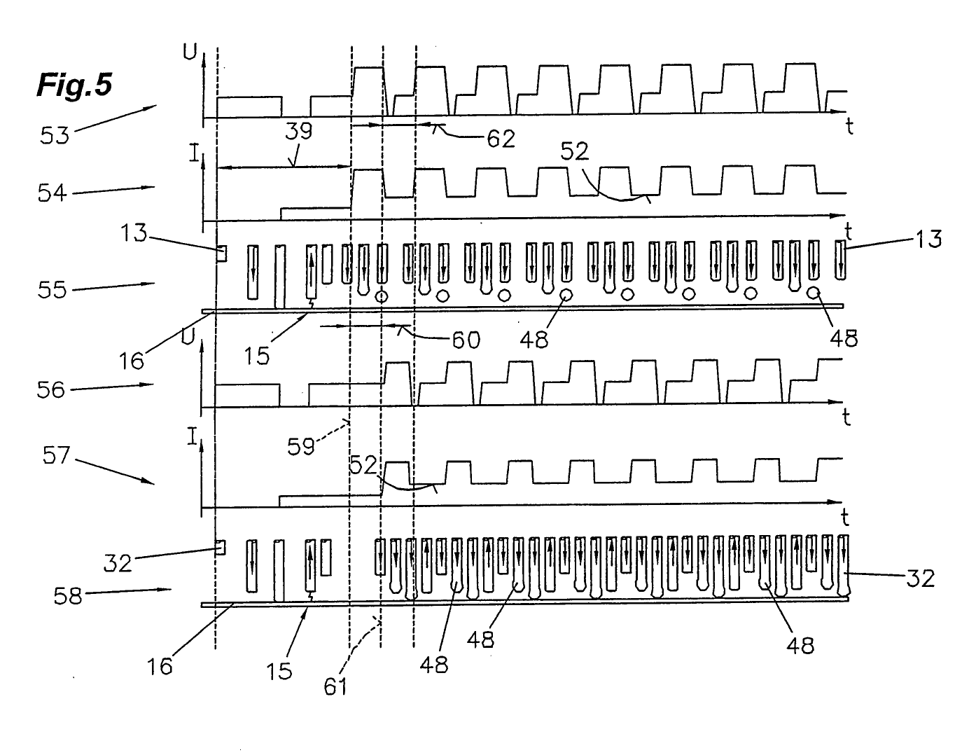

In the MIG/MAG welding process of the first welding torch 10, it is also feasible to adjust other known welding methods such as, for instance, a pulse method, a short-circuit method etc. The graphs depicted in FIGS. 4 and 5, for instance, illustrate a pulse welding process combined with a cold-metal transfer welding process. First graph 53 shows a current-time graph of the pulse welding process, graph 54 a voltage-time graph of the pulse welding process, graph 55 a wire movement graph of the pulse welding process, graph 56 a current-time graph of a cold-metal transfer welding process, graph 57 a voltage-time graph of the cold-metal transfer welding process and graph 58 a wire movement graph of the cold-metal transfer welding process.

There is no detailed description of the pulse welding process, since this is already well known from the prior art. It is merely pointed out that in the pulse welding process, after an ignition phase 39, which is, for instance, again carried out according to the lift-arc principle, a droplet 48 is formed on the welding wire 13 by the application of a current pulse at time 59—pulse current phase 60—and detached from the welding wire end at time 61. After this, the current I is lowered to a defined base current 52-base current phase 62. By cyclically applying the pulse current phase 60 and the base current phase 62, a droplet 48 is detached from the welding wire 13 per pulse current phase 60 so as to ensure the defined material transfer to the workpiece 16.

In this exemplary embodiment, the pulse welding process is combined with a cold-metal transfer welding process, wherein the cold-metal transfer welding process is not discussed in detail, since it has already been described with reference to FIGS. 2 to 5. The combination according to the invention enables, for instance, the use of only one power source 2, which is alternately connected to the respectively active welding torch 10, 35. It is, of course, also possible to control the welding processes by using two independently operating power sources 2, 38. The welding processes can, thus, be mutually synchronized so as to enable, for instance, an isochronic droplet detachment from the welding wire 13.

With the exemplary embodiment illustrated in FIG. 4, it is essential that controlling is effected in a manner that the droplet detachment in the pulse welding process takes place synchronously with the droplet detachment in the cold-metal transfer welding process. Thus, a droplet 48 is detached in the pulse welding process, and at the same time a droplet 48 is detached in the cold-metal transfer welding process, cf. time 61. Naturally, it is not necessarily required that the droplet detachments of the individual welding processes take place at the same time. The droplet detachment of the cold-metal transfer welding process may, of course, also be controlled to occur in a temporally offset manner relative to the pulse welding process, particularly during the base current phase 62 of the pulse welding process, as is apparent from FIG. 5.

Basically, it should be noted that, in the illustrated exemplary embodiment of the combined pulse-welding process and cold-metal transfer welding process, the cold-metal transfer welding process carried out via the second welding torch 35 follows upon the first welding torch 10, viewed in the welding direction. A substantial advantage resides in that substantially less heat and energy are introduced into the workpiece 16 during the cold-metal transfer welding process and, hence, more welding material will be obtained by the combination of a MIG/MAG welding process with the cold-metal transfer welding process at a slight increase in the heat input. It merely needs to be added that two separately controllable current sources are arranged in the welding apparatus 1 to supply energy to the welding torches 10, 35 arranged in the welding torch unit 29. This is, however, not necessarily required, since the welding torches 10, 35 can also be controlled by a single current source which is alternately connected with the respectively active welding torch 10, 35.

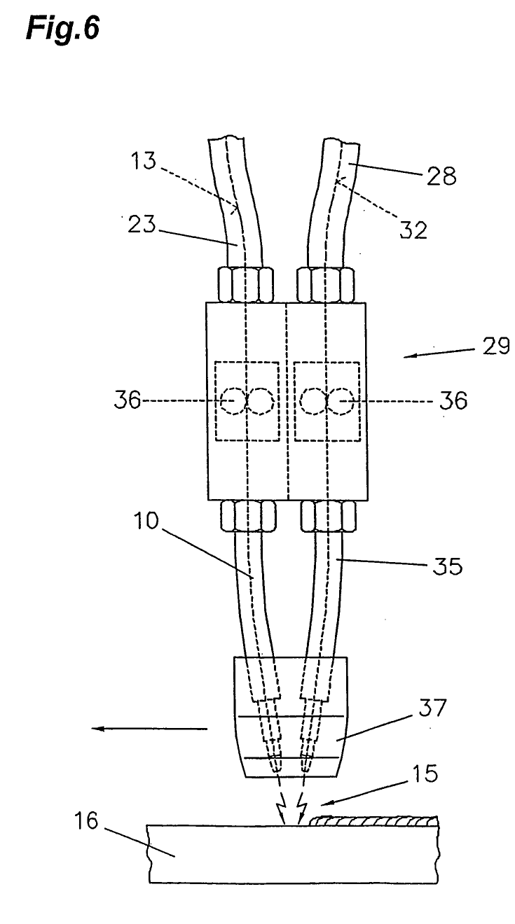

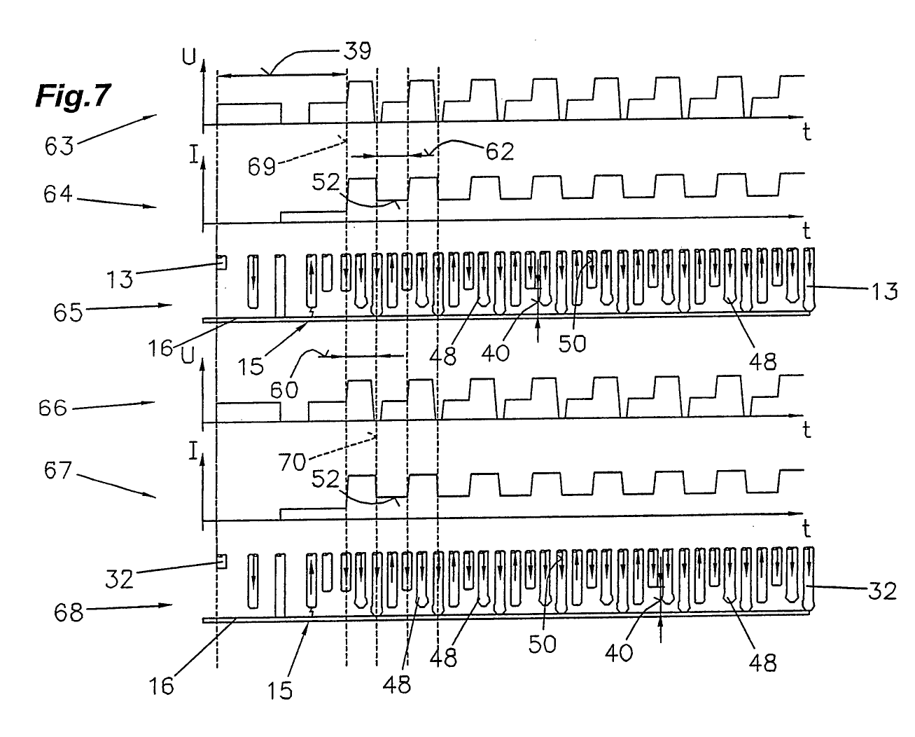

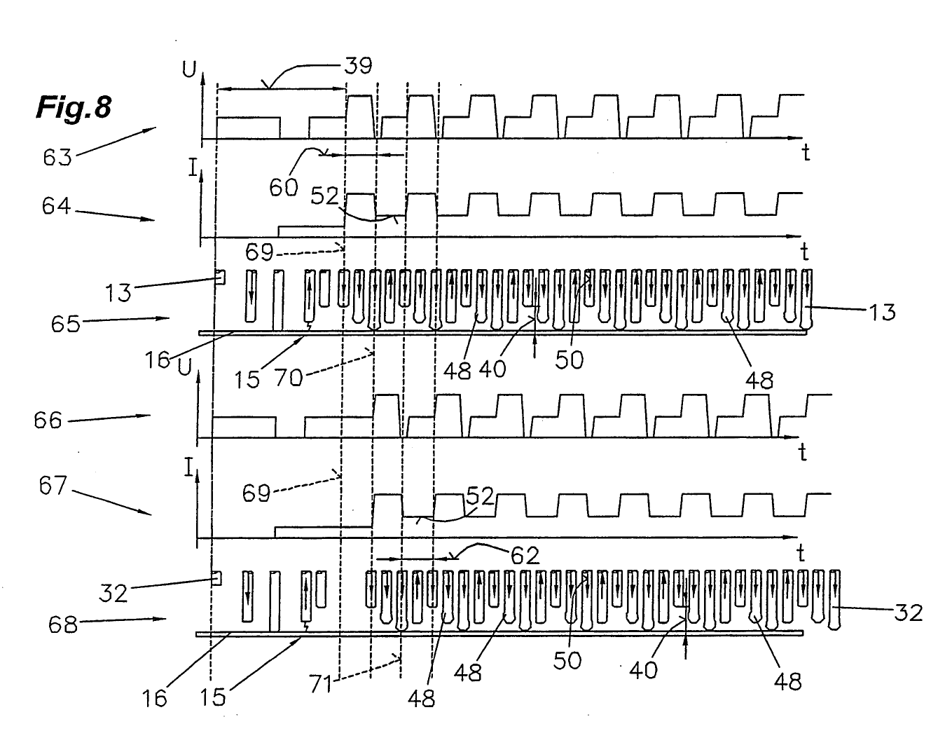

In order to be able to control, or further reduce, the heat input into the workpiece 16, it is also possible to configure also the first welding torch 10 to perform a cold-metal transfer welding process. It merely needs to be added that, for enabling the realization of a cold-metal transfer welding process, each of the welding torches 10, 35 comprises its own drive unit 36, as is schematically illustrated in FIG. 6. In addition, the two cold-metal transfer welding processes are mutually synchronized, i.e.,droplet detachments from the welding wire 13, for instance, take place simultaneously—FIG. 7—, while droplet detachments may, of course, also be temporally offset, as is schematically illustrated in FIG. 8.

There is no detailed description of the cold-metal transfer welding process, since this has already been extensively explained in the previously described FIGS. 2 to 5. It is merely pointed out that the cold-metal transfer welding process is started after an ignition phase 39, which is, for instance, again carried out according to the lift-arc principle, as is schematically illustrated in FIGS. 7 and 8. Therein, graph 63 is a voltage-time graph, graph 64 is a current-time graph, and graph 65 is a movement graph of the first cold-metal transfer welding process, while graphs 65, 66 and 67 likewise depict a voltage-time graph, a current-time graph and a movement graph, respectively, of the second cold-metal transfer welding process.

At a time 69—end of the ignition phase 39—the welding current I is increased by a limited extent, i.e., a current pulse is applied, which forms the pulse current phase 60 as is apparent from the graphs of the two welding processes according to FIG. 7, while in FIG. 8 the second cold-metal transfer welding process is started in a temporally offset manner, i.e., delayed by the pulse current phase 60 of the first cold-metal transfer welding process. During the pulse current phase 60, the welding wire 13, 32 is conveyed in the direction of the workpiece 16—arrow 50, with a droplet 48 forming on the wire end due to the elevated welding current applied. The welding wire 13, 32 is conveyed in the direction of the workpiece 16 until contacting the workpiece 16 at time 70 and subsequently is again moved back as far as to a starting position, i.e. distance 40, after the formation of a short-circuit. Droplet detachment is achieved by immersion into the melt bath (not illustrated). In FIG. 8, the welding current I is raised in the delayed, second cold-metal transfer welding process at time 70, thus initiating the pulse current phase 60.

At time 70, the welding current I is lowered to the base current 52—base current phase 62—in order to prevent the formation of a droplet or incipient melting of the welding wire 13, 32, while the base current phase 62 in the second cold-metal transfer welding process represented in FIG. 8 in a delayed manner is again initiated in a temporally offset manner, as is to be seen at time 71.

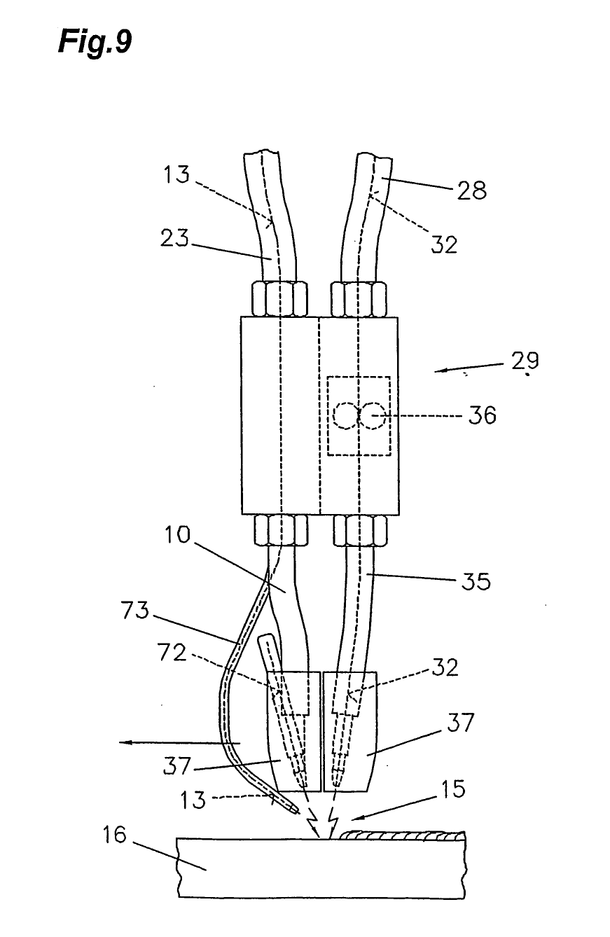

It may, of course, also be contemplated to design the first welding torch 10 as a WIG welding torch, with the WIG welding process being combined with a cold-metal transfer welding process, as is schematically illustrated in FIG. 9. It is, thus, feasible, on account of the additional energy source of the WIG welding process, to obtain, for instance, elevated heating and, hence, melting of the workpiece 16, while only a slight additional heat input is effected by the cold-metal transfer welding process. It is, of course, also possible to carry out the cold-metal transfer welding process via the first welding torch 10, while the WIG welding process is performed through the second welding torch 35, whereby, for instance, the penetration depth in the workpiece 16 will be reduced and the WIG welding process will consequently smooth the weld, thus increasing the quality of the weld.

In this case, a non-consumable electrode 72, for instance a tungsten electrode, is arranged in the first welding torch 10 of the welding torch unit 29 in the region of the gas nozzle 37. The gas nozzle 37 in this exemplary embodiment is separate, i.e., the two welding torches 10, 35 for the two independent, separate welding process, namely the WIG welding process and the cold-metal transfer welding process, each have their own gas nozzles 37. Only one thermally and electrically separated gas nozzle 37 is illustrated. This offers the advantage that, for instance, different welding gases and, hence, different gas pressures can be used for the two independent welding processes. As a result, also the quality of the weld will, for instance, be enhanced, since for each welding process the respectively optimum welding gas is used. The welding wire 13, i.e., the weld metal for the WIG welding process, is supplied to the welding torch 10 and conveyed into the electric arc 15 of the welding torch 10 through a tube 73. Since the WIG welding process constitutes a welding process known from the prior art, it will not be explained in detail in the description. As already mentioned above, the cold-metal transfer welding process is combined with a WIG welding process, and, again, the cold-metal transfer welding process will not be explained in detail, since is has already been described by way of FIGS. 2 to 5.

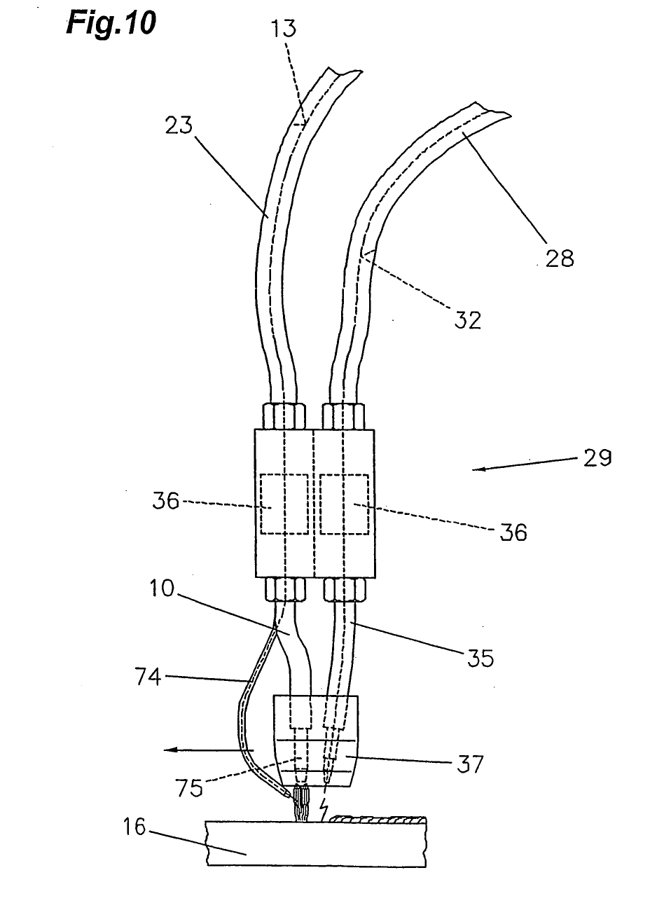

In the exemplary embodiment according to FIG. 10, a welding process formed by a plasma torch is combined with a cold-metal transfer welding process. Since the plasma welding process is already well known from the prior art, the plasma welding process will not be described in detail. It is merely pointed out that the electric arc 15 in a plasma welding process is ignited in a gas nozzle 74 through HF ignition. The electric arc 15 burns within the gas nozzle 74 with only a hot, ionized plasma jet 75 emerging from the gas nozzle 74. After the ignition phase 39 (not illustrated), a welding current reduced relative to the ignition phase 39 is applied in order to maintain the electric arc 15. The plasma jet 75 causes the workpiece 16 to melt. Also conveyed into the plasma jet 75 is the welding wire 13, i.e. the weld metal, through a tube 73 arranged on the welding torch 10 of the welding torch unit 29. Continuous droplet detachment is thereby ensured.

It is, of course, also possible to configure the gas nozzle 37 in the combined plasma welding process and cold-metal transfer welding process as a separate gas nozzle 37, as has already been described in FIG. 9 in respect to the combination of a WIG welding process with a cold-metal transfer welding process. In this exemplary embodiment, the cold-metal transfer welding process is combined with the plasma welding process, wherein the cold-metal transfer welding process will not be explained in detail, since is has already been described by way of FIGS. 2 to 5.

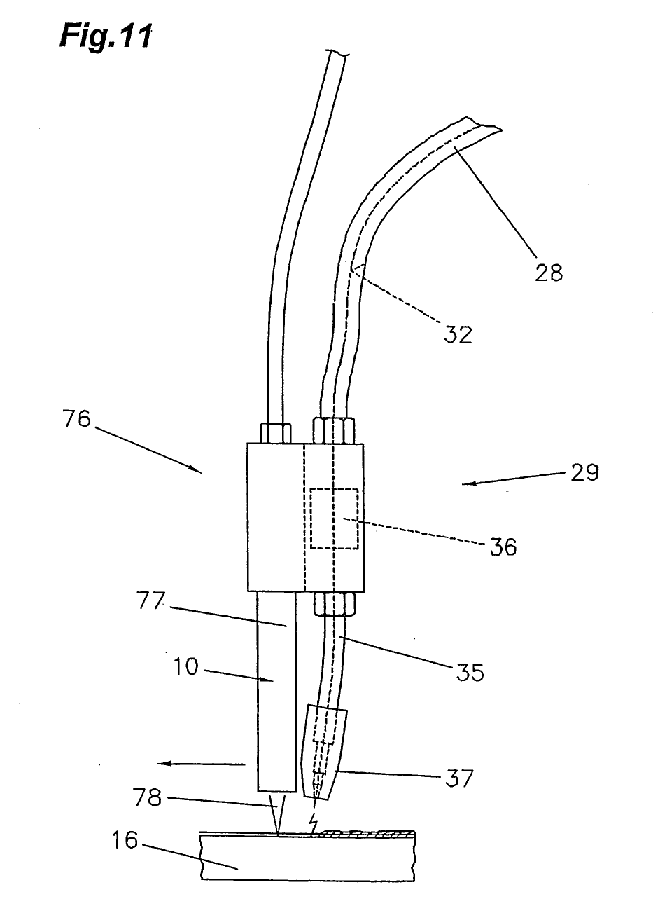

Naturally, it is also feasible to replace the first welding torch 10 with a laser unit 76, which laser unit 76 in the welding torch unit 29 is combined with the second welding torch 35 for the cold-metal transfer welding process. Such a variant is illustrated in FIG. 11. The laser unit 76 may, of course, also be arranged outside the welding torch unit 29.

This configuration offers the advantage that the weld will be substantially reduced at an increased welding rate when using a laser 77 or laser optics, since the laser jet 78 allows for a defined penetration depth into the workpiece 16 with the consecutively provided cold-metal transfer welding process filling the prepared seam. Hence, a less precise preparatory work of the weld will be required, since an enhanced gap bridging ability is ensured. The laser unit 76, which constitutes the welding torch 10 in this exemplary embodiment, is again combined with the cold-metal transfer welding process.

In respect to the described exemplary embodiments, it merely needs to be added that the welding torches 10, 35 are designed in a manner that the welding torches 10, 35 are able to receive different welding wires and welding wire diameters. No replacement of the necessary structural components will, hence, be required for the wire conveyance at a change of the welding wire, which renders any conversion operations by the user superfluous.

1. A welding unit (27) including a welding apparatus (1) with a welding torch unit (29) connectable thereto via a hose pack (23, 28), wherein at least one control device (4), a welding current source (2) and optionally a wire feeder unit (30) are arranged in the welding apparatus (1), wherein the welding torch unit (29) is formed by at least two separate welding torches (10, 35) intended to carry out at least two independent, separate welding processes, wherein the first welding torch (10) is configured to carry out a welding process and at least a second welding torch (35) is configured to carry out a cold-metal transfer welding process with a forward-backward movement of a welding wire (32), and that a device for synchronizing the welding processes carried out by the at least two welding torches (10, 35) is provided.

2. A welding unit (27) according to claim 1, wherein the first welding torch (10) is comprised of a WIG/MAG welding torch.

3. A welding unit (27) according to claim 1, wherein the first welding torch (10) is comprised of a WIG welding torch.

4. A welding unit (27) according to claim 1, wherein the first welding torch (10) is comprised of a plasma burner.

5. A welding unit (27) according to claim 1, wherein the first welding torch (10) is likewise designed to carry out a cold-metal transfer welding process.

6. A welding unit (27) according to claim 1, wherein the first welding torch (10) is comprised of a laser unit (76) which, in the welding torch unit (29), is combined with the second welding torch (35) for the cold-metal transfer welding process.

7. A welding unit (27) according to claim 1, wherein the first welding torch (10) precedes the second welding torch (35) in the welding direction.

8. A welding unit (27) according to claim 1, wherein two separately controllable current sources (2, 38) are arranged in the welding apparatus (1) to supply the welding torch unit (29) with energy.

9. A welding unit (27) according to claim 1, wherein only one current source (2) is arranged in the welding apparatus (1) to supply the welding torch unit (29) with energy, which current source is alternately connected with the respectively active welding torch (10, 35).

10. A welding unit (27) according to claim 1, wherein the at least two welding torches (10, 35) comprise a common gas nozzle (37).

11. A welding unit (27) according to claim 1, wherein the at least two welding torches (10, 35) of the welding torch unit (29) are laterally offset relative to one another in the longitudinal direction of the weld, i.e., in the welding direction.

12. A welding unit (27) according to claim 1, wherein the welding wires (13, 32) of the at least two welding torches (10, 35) are comprised of different materials.

13. A welding unit (27) according to claim 1, wherein the welding wires (13, 32) of the at least two welding torches (10, 35) have different diameters.

14. A welding method combining at least two different welding processes, wherein at least welding process is comprised of a cold-metal transfer welding process, wherein a consumable welding wire is moved forward and backward, and that the at least two welding processes are synchronized in time.

15. A welding method according to claim 14, wherein a welding process is comprised of a MIG/MAG welding process.

16. A welding method according to claim 14, wherein a welding process is comprised of a WIG welding process.

17. A welding method according to claim 14, that wherein a welding precess is comprised of a plasma welding process.

18. A welding method according to claim 14, wherein at least two welding processes are comprised of a cold-metal transfer welding process.

19. A welding method according to claim 14, wherein a welding process is comprised of a laser welding process.

20. A welding method according to claim 14, wherein the cold-metal transfer welding process follows the other welding process(es) in the welding direction.

21. A welding method according to that claim 14, wherein at least two welding processes using consumable welding wires are temporally synchronized in a manner that the droplet detachments from the welding wires of the at least two welding processes take place simultaneously.

22. A welding method according to claim 14, wherein at least two welding processes using melting welding wires are temporally synchronized in a manner that the droplet detachment from the welding wire of one welding process takes place in a manner temporally offset relative to the droplet detachment of the other welding process(es).
